(19) United States
(12) Patent Application Publication
(10) Pub. No.: US 2008/0087504 A1
(43) Pub. Date: Apr. 17, 2008

(54) Roller housing having retaining arms

(76) Inventor: Jacob Kobelt, Surrey (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/581,215

(22) Filed: Oct. 13, 2006

(51) Int. Cl. F16D 55/08

(52) U.S. Cl. 188/72.7

(57) ABSTRACT

In a braking device having a pair of opposed arms rotatable about parallel axes having first ends coupleable to opposing brake pads to brake a disk therebetween, a cam follower connected to the second ends and retainable against a cam is disclosed. The braking device further including an actuated cam having a pair of opposed flanges disposed intermediate the cam followers. The flanges include a cam surface and back surfaces. The cam follower comprises a cam following surface for slidably engaging the cam surface and retaining portions extending from the cam follower around the flanges to engage the back surfaces to retain the cam following surface against the cam surface.

### BACKGROUND OF THE INVENTION

1. Field of Invention

The present invention relates generally to brakes and in particular to an apparatus retaining a cam follower against a cam in a cam actuated brake.

2. Description of Related Art

Brakes for rotating disks are well known. A common brake for such disks is known as a caliper brake. A caliper brake provides a pair of brake pads disposed on either side of the rotating disk. Each brake pad may be attached to an arm at a proximate end. The arms are rotatable about an intermediate axis and actuated by an actuator between the distal ends thereof.

An example of a cam actuated caliper brake assembly is shown in U.S. Pat. No. 4,121,697 to Kobelt et al., the entirety of which is incorporated herein by reference. U.S. Pat. No. 4,212,697 to Kobelt et al. provides a wedge or cam between a pair of followers on the distal ends of the arms.

A present difficulty with disk brakes arises when the actuator releases the actuating force from the cam or wedge. As the actuator retracts the cam or wedge from the cam followers, any binding of the arm pivots may cause the cam to come out of contact with the cam followers. This may in turn lead to fouling of the cam surface while it is not in contact with the cam followers.

In addition, as the cam followers may be pivotally connected to the arms, removing the contact between the cam follower and the cam may permit the cam followers to rotate out of alignment with the cam. Subsequent application of the brake may not succeed in realignment of the cam follower with the cam but rather may cause the cam to contact a side portion of the cam follower or the arm thereby damaging one or more components of the brake.

Previous attempts to solve the present problem has been to provide springs between the ends of the arms so as to bias the cam followers against the cam.

What is desirable is a cam actuated brake assembly which maintains the cam followers in contact with the cam so as to prevent misalignment of the brake apparatus.

### SUMMARY OF THE INVENTION

The present invention provides a cam actuated brake assembly in which the cam followers are maintained in contact with the cam so as to prevent misalignment of the brake apparatus.

According to a first embodiment of the present invention there is provided a cam follower retainable against a cam in a braking device. The braking device has a pair of opposed arms rotatable about parallel axes. The opposed arms have first ends coupleable to opposing brake pads to brake a disk therebetween and second ends which have the cam followers. The braking device further has an actuated cam which has a pair of opposed flanges disposed intermediate the cam followers. The flanges have cam surfaces and back surfaces. Each cam follower comprises a cam following surface for slidably engaging the cam surfaces and retaining portions extending from the cam follower around the flanges to engage the back surfaces to retain the cam following surface against the cam surface.

According to a further embodiment of the present invention there is provided a brake apparatus for braking a disk. The brake apparatus comprises a pair of opposed arms rotatable about parallel axes having first and second ends. The first ends are adapted to be coupled to opposing brake pads to brake a disk therebetween. The brake apparatus further comprises an actuated cam having a pair of opposed flanges disposed intermediate the second ends of the arms. The flanges have a cam surfaces and back surfaces. The brake apparatus further comprises cam followers connected to the second ends of the arms. Each of the cam followers comprises a cam following surface for slidably engaging the cam surface and retaining portions extending from the cam follower around the flanges to engage the back surfaces to retain the cam following surfaces against the cam surfaces.

### BRIEF DESCRIPTION OF THE DRAWINGS

In drawings which illustrate embodiments of the invention,

FIG. 1 is a plan view of a first embodiment of the brake assembly according to the present invention;

FIG. 2 is a side elevation view of the brake assembly of FIG. 1;

FIG. 3 is a rear elevation view of the brake assembly of FIG. 1; and

FIG. 4 is a cross sectional view of the cam following assembly and wedge flange taken along the line 4-4 of FIG. 3.

### DETAILED DESCRIPTION

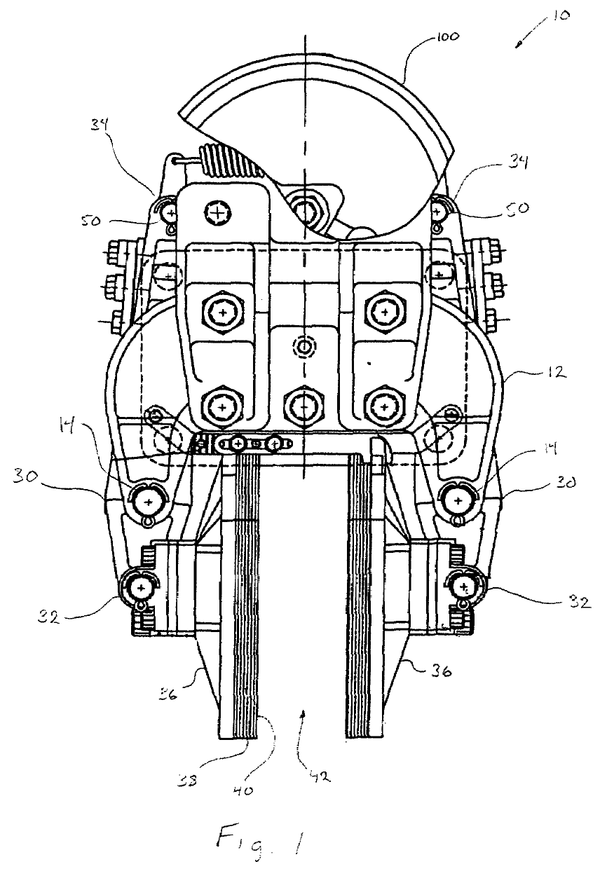

Referring to FIG. 1, a brake assembly according to a first embodiment of the invention is shown generally at 10. The brake assembly 10 comprises a frame 12, supporting a pair of arms 30 and an actuator 100. The frame 12 comprises a body having a pair of pivots 14 pivotally supporting the arms 30.

The arms 30 comprise elongated members having first and second ends 32 and 34 respectively and are rotatably connected to the frame 12 at pivots 14. The arms support a brake pad assembly 36 at each first end 32. The brake pad assemblies include brake pads 38 having brake pad surfaces 40. The brake pad assembly 36 of the arms 30 are disposed opposite each other to form a passage 42 therebetween. The passage may receive a disk brake (not shown) or other object to be braked or retained.

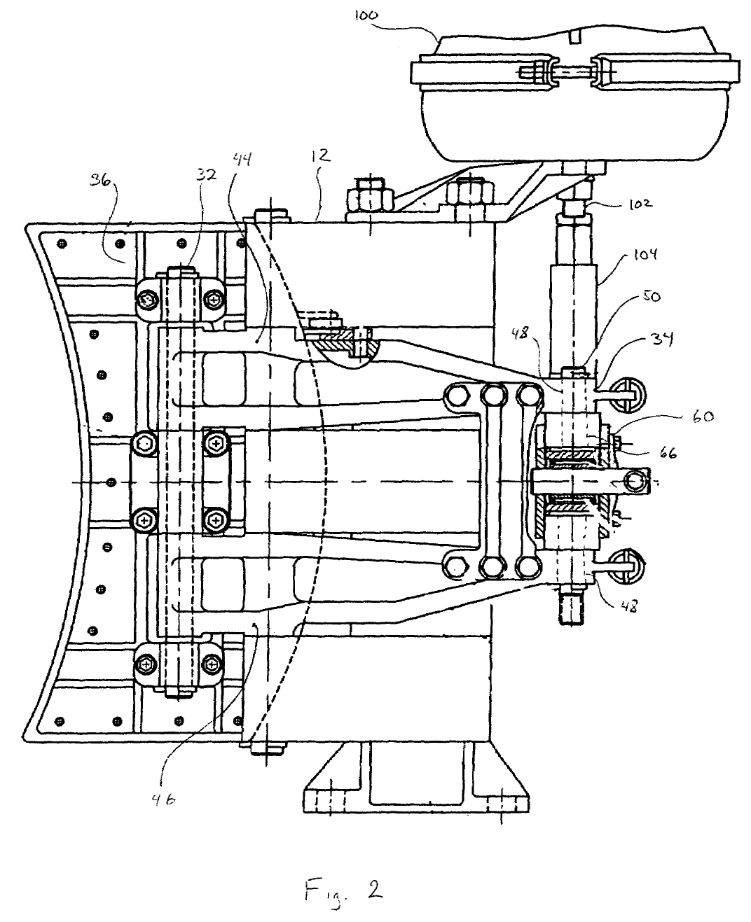

Referring now to FIG. 2, a side elevation view of the brake apparatus is shown in which the second ends 34 of the arms 30 have a cam following assembly 60. In the embodiment shown in FIG. 2, the arms 30 are formed from first and second spaced arm portions 44 and 46, respectively. The first and second arm portions 44 and 46, each include a bore 48 able to receive a cam follower support pin 50. The cam follower support pin 50 is received within a coaxial bore 66 in the cam following assembly 60 so as to rotatably connect the cam following assembly to the second end 34 of the arms 30.

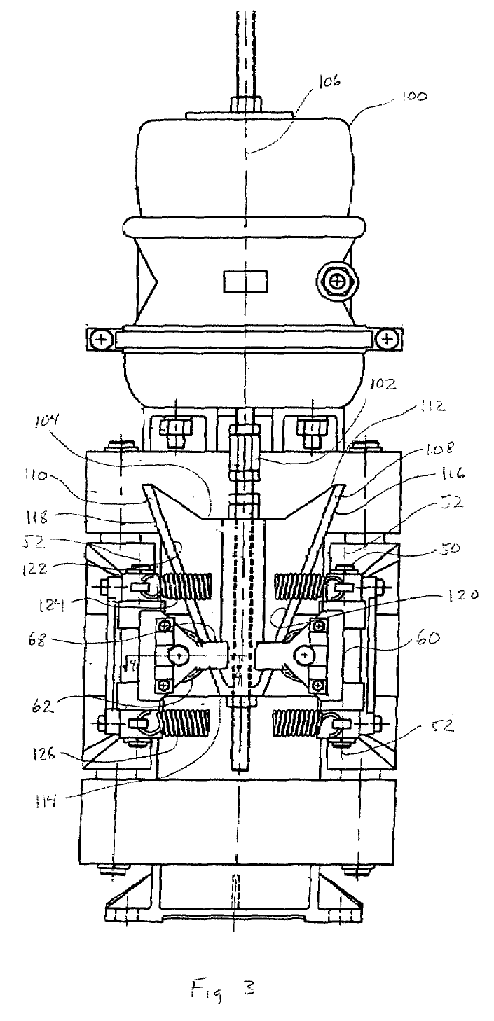

In FIG. 3 a rear elevation view of the brake assembly is shown. Actuator 100 is connected to the frame 12 and includes an actuator rod 102 driving a cam or wedge 104 disposed about an actuator axis 106. The actuator axis is in planar alignment with the cam following assemblies 60 such that the wedge 104 is disposed between the two cam following assemblies 60. The cam or wedge comprises a wedge shaped body having first and second angularly disposed flanges 108 and 110 and a proximate and distal end 112 and 114, respectively. Flanges 108 and 110 include respective first and second cam surfaces 116 and 118 which are oriented such that they are closer together at the distal end 114 of the wedge than at the proximate end 112.

The cam following assembly 60 comprises a body having a first axis of rotation 52 defined by the cam follower support pin 50, and includes a cam follower or roller 62. The roller comprises a cylindrical body rotatably connected to the cam following assembly 60 about an axis perpendicular to first axis 52. The cam following assembly further includes extended retaining portions or arms 68 extending past and engaging upon the back surfaces or faces 120 and 122 of the flanges 108 and 110. The ends of the two arms may further be biased towards each other by means of springs 124 and 126.

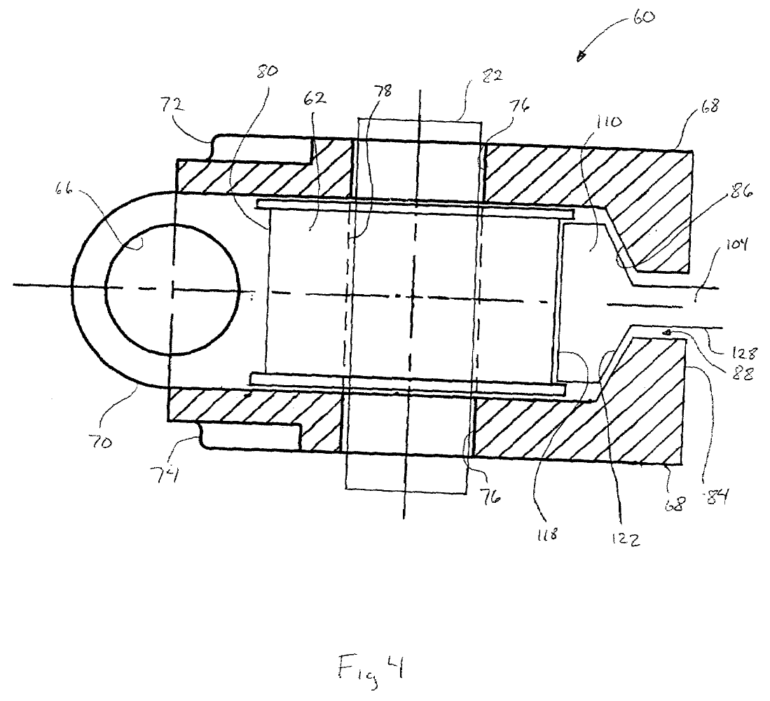

FIG. 4 shows a cross-sectional view of the cam following assembly 60 and wedge 104 along the line 4-4 of FIG. 3. As best shown in FIG. 4, the cam following assembly 60 contains the roller 62 and retains the roller in contact with wedge 104. Wedge 104 includes a second flange 110 and a web portion 128. The flange includes an externally facing cam surface 118 and back surfaces 122 adjacent to the web portion 128.

Each cam following assembly 60 includes a housing 70 comprising first and second sides 72 and 74. Each of said first and second sides includes an extended retaining arm 68 and a roller pin bore 76. The roller 62 is received between the first and second sides 72 and 74 and includes a central bore 78. The roller further includes an external annular cam following surface 80. The roller is rotatably secured in position between the first and second sides 72 and 74 by roller pin 82. The retaining arm 68 include an internal lip portion 84 containing the flange between the lip portion and the roller 62 and having a retaining surface 86 facing towards and complementary with the back surfaces 122 of the flange 110. The lip portions form an opening 88 therebetween through which the web portion 128 of the wedge 104 may pass.

Operation

Referring to FIGS. 1 through 3, in operation, when the brake apparatus is required to brake the disk in passage 42, the actuator 100 is supplied with an actuation signal such as for example, a hydraulic, pneumatic, or electrical signal. The actuator 100, in response to the actuation signal, displaces the actuator rod 102 and the cam or wedge 104 towards the following rollers 62. As the wedge is driven between the rollers 62, the rollers and thereby the following assemblies 60 are forced apart by the first and second cam surfaces 116 and 118. The outward movement of the following assemblies 60 correspondingly moves the second ends 34 of the arms 30 rotationally outward about the pivots 14. The rotation of the arms about pivots 14 causes the first ends 32 and arms 30 and thereby the brake pad assemblies to be displaced inwardly toward each other to narrow the width of the passage 42 therebetween. After a sufficient movement of the brake pads 38, the brake pad surfaces 40 will frictionally engage the disk therebetween thereby providing a braking force to the disk.

As best shown in FIG. 4, when the actuator 100 releases the actuating force from the wedge 104, the wedge will be raised relative to the cam following assemblies 60. As the wedge 104 is raised relative to the cam following assemblies 60, the flanges 108 and 110 will be pulled away from the rollers 62 due to the angular disposition of the flanges as descibed above. As the flanges are pulled away from the roller, the back surface 120 or 122 of each flange will contact the retaining surface 86 of the lip portion 84 of the roller housing 70. As the wedge 104 is further raised relative to the cam following assemblies 60 and the flanges 108 and 110 are pulled away from the rollers 62, the retaining arm 68 will pull the roller housings 70 towards the wedge 104 so as to retain the rollers 62 proximate to the flanges 108 and 110.

While specific embodiments of the invention have been described and illustrated, such embodiments should be considered illustrative of the invention only and not as limiting the invention as construed in accordance with the accompanying claims.

What is claimed is:

1. A cam follower retainable against a cam in a braking device, the braking device having a pair of opposed arms rotatable about parallel axes having first ends coupleable to opposing brake pads to brake a disk therebetween and second ends having the cam followers, the braking device having an actuated cam having a pair of opposed flanges disposed intermediate the cam followers, the flanges having cam surfaces and back surfaces, each cam follower comprising a cam following surface for slidably engaging said cam surfaces and retaining portions extending from the cam follower around the flanges to engage said back surfaces to retain said cam following surface against said cam surface.

2. The cam follower of claim 1 wherein said cam follower further includes a roller wherein said cam following surface comprises an exterior annular surface of said roller.

3. The cam follower of claim 2 wherein said cam follower further includes a housing wherein said roller is rotatably connected to said housing.

4. The cam follower of claim 3 wherein said roller is contained within said housing.

5. The cam follower of claim 3 wherein said retaining portions comprises arms extending from said housing.

6. The cam follower of claim 4 wherein said retaining portions comprise a pair of arms having said roller therebetween.

7. The cam follower of claim 1 wherein said cam follower is pivotally connectable to the second end of the arms about cam axes parallel to the arm

8. A brake apparatus for braking a disk, the brake apparatus comprising:
a pair of opposed arms rotatable about parallel axes having first and second ends, said first ends adapted to be coupled to opposing brake pads to brake a disk therebetween;
an actuated cam having a pair of opposed flanges disposed intermediate said second ends of said arms, the flanges having cam surfaces and back surfaces; and
cam followers connected to said second ends of said arms, each of said cam followers comprising a cam following surface for slidably engaging said cam surface and retaining portions extending from said cam follower around said flanges to engage said back surfaces to retain said cam following surfaces against said cam surfaces.

9. The brake apparatus of claim 8 wherein said cam follower further includes a roller wherein said cam following surface comprises an exterior annular surface of said roller.

10. The brake apparatus of claim 9 wherein said cam follower further includes a housing wherein said roller is rotatably connected to said housing.

11. The brake apparatus of claim 10 wherein said roller is contained within said housing.

12. The brake apparatus of claim 10 wherein said retaining portions comprises arms extending from said housing.

13. The brake apparatus of claim 11 wherein said retaining portions comprise a pair of arms having said roller therebetween.

14. The brake apparatus of claim 8 wherein said cam follower is pivotally connectable to the second end of the arms about cam axes parallel to the arm
